(19) United States
(12) Patent Application Publication
(10) Pub. No.: US 2013/0078497 A1
(43) Pub. Date: Mar. 28, 2013

(54) NONAQUEOUS ELECTROLYTE SECONDARY BATTERY

(71) Applicant: SANYO ELECTRIC CO., LTD., Moriguchi City (JP)

(72) Inventors: Yuji Tani, Sumoto-City (JP); Shinya Miyazaki, Naruto-City (JP)

(73) Assignee: SANYO ELECTRIC CO., LTD., Moriguchi City (JP)

(21) Appl. No.: 13/627,395

(22) Filed: Sep. 26, 2012

(30) Foreign Application Priority Data
Sep. 27, 2011 (JP) 2011-210513

(51) Int. Cl. H01M 2/02; H01M 2/08

(52) U.S. Cl. 429/149

(57) ABSTRACT

A nonaqueous electrolyte secondary battery according to an embodiment of the present invention includes a stacked electrode assembly in which positive electrode plates and negative electrode plates are stacked with separators interposed therebetween, and that is housed, together with a nonaqueous electrolyte, in a laminate outer casing. A negative electrode active material layer is formed on the surface of negative electrode substrates of the negative electrode plates. The negative electrode active material layer contains spheroidal graphite, scalelike graphite, and carboxymethyl cellulose. The average specific surface area of the spheroidal graphite and the scalelike graphite is 2.0 to 4.0 m²/g, the degree of etherification of the carboxymethyl cellulose is 0.8 to 1.5, and the packing density of the negative electrode active material layer is 1.3 to 1.8 g/cc. This yields a nonaqueous electrolyte secondary battery with superior cycling characteristics at high rate.

### TECHNICAL FIELD

The present invention relates to a nonaqueous electrolyte secondary battery in which a stacked electrode assembly is housed together with a nonaqueous electrolyte inside a laminate outer casing.

### BACKGROUND ART

Nonaqueous electrolyte secondary batteries, typified by lithium ion secondary batteries, have been much used in recent years as drive power sources for portable electronic equipment such as mobile telephones, portable personal computers and portable music players. Furthermore, electric vehicles (EVs), hybrid electric vehicles (HEVs), plug-in hybrid electric vehicles (PHEVs), electric motorcycles and other electrically powered vehicles, which use nonaqueous electrolyte secondary batteries, are being energetically developed against a background of soaring oil prices and an intensifying environmental protection movement. Progress is also being made with development of medium- and large-size nonaqueous electrolyte secondary batteries for use as secondary batteries in large-size electricity storage systems, which have the purpose of storing midnight power and photovoltaically generated power.

High capacity and high energy density are required of such nonaqueous electrolyte secondary batteries used in electrically powered vehicles, large-size electricity storage systems, and so forth. In addition, enhanced battery characteristics (high rate cycling characteristics) are also strongly required for cases where cycling is executed with large current, due to the need to execute rapid charging and high-load discharging. For the nonaqueous electrolyte secondary batteries used in electrically powered vehicles, large-size electricity storage systems and so forth, the required service lives are long compared with the batteries for small-size portable equipment, and it is important that their battery characteristics do not decline when cycling becomes advanced.

JP-A-2006-59690 discloses use of a mixture of 90 parts by weight of spheroidized natural graphite and 10 parts by weight of scalelike graphite, in connection with technology having the purpose of providing a nonaqueous electrolyte secondary battery with enhanced cycling lifespan. It also discloses the use of carboxymethyl cellulose with a 0.6 to 0.8 degree of etherification.

JP-A-2001-135356 discloses that a battery with superior cycling characteristics can be obtained by using scalelike natural graphite processed into a spheroidal form as the negative electrode active material. It further discloses the use of scalelike natural graphite not processed into a spheroidal form, together with the scalelike natural graphite processed into a spheroidal form, as the negative electrode active material.

The inventors discovered, while proceeding with research for a nonaqueous electrolyte secondary battery suited for executing cycling with large current (high rate), the issue that when cycling was executed with high rate, the battery capacity declined as cycling progressed. Such issue could not be adequately resolved even by using the technologies disclosed in the foregoing JP-A-2006-59690 and JP-A-2001-135356.

### SUMMARY

An advantage of some aspects of the invention is to provide a nonaqueous electrolyte secondary battery in which the battery capacity is curbed from declining even when cycling is executed at high rate.

According to an aspect of the invention, a nonaqueous electrolyte secondary battery includes a stacked electrode assembly in which positive electrode plates and negative electrode plates are stacked with separators interposed therebetween, and that is housed, together with a nonaqueous electrolyte, in a laminate outer casing. A negative electrode active material layer is formed on the surface of negative electrode substrates of the negative electrode plates. The negative electrode active material layer contains spheroidal graphite, scalelike graphite, and carboxymethyl cellulose. The average specific surface area of the spheroidal graphite and the scalelike graphite is 2.0 to 4.0 m²/g, the degree of etherification of the carboxymethyl cellulose is 0.8 to 1.5, and the packing density of the negative electrode active material layer is 1.3 [symbol] 1.8 g

This aspect of the invention yields a nonaqueous electrolyte secondary battery in which, thanks to the synergistic effects of the components, the battery capacity is curbed from declining even when cycling is executed

In this invention, “spheroidal graphite” refers to graphite with an aspect ratio (major axis/minor axis) of not more than 2.0, and “scalelike graphite” refers to graphite with an aspect ratio (major/ [symbol] axis) of not less than 5.0. Note that the aspect ratio can be determined by, for example, using a scanning electron microscope to obtain an enlarged view of the particles (enlarged by a factor of 1000, for example).

In the invention, the average specific surface area of the spheroidal graphite and the scalelike graphite is found in the following manner. First, the BET specific surface areas of the spheroidal graphite and of the scalelike graphite are found. Then, the following equation is used to determine the average specific surface area, where A is the BET specific surface area of the spheroidal graphite, B is the BET specific surface areas of the scalelike graphite, C is the mass of the spheroidal graphite contained in the negative electrode active material layer, and D is the mass of the scalelike graphite contained in the negative electrode active material layer:

Average specific surface area of spheroidal and scalelike graphites=A×(C/(C+D))+B×(D/(C+D))

In the invention, an item having a structure represented by the following general formula may be used as the carboxymethyl cellulose:

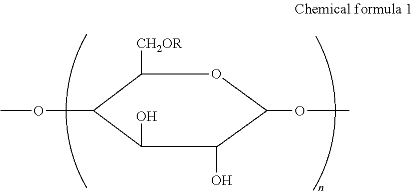

(where R represents H or CH₂COOX, X is one item selected from among Na, NH₄, Ca, K, Al, Mg and H, and if more than one R and/or more than one X is present, they may be the same as or different from each other).

It is preferable that the quantity of CMC contained in the negative electrode active material layer be 0.5 to 4.0% by mass relative to the total quantity of the negative electrode active material. Thereby, the negative electrode plates will have superior adhesion between the negative electrode active materials and between the negative electrode active material layers and the negative electrode substrates.

Thanks to the packing density of the negative electrode active material layer being 1.3 to 1.8 g/cc, the nonaqueous electrolyte secondary battery of the invention will be suitable for cycling at high rate.

The degree of etherification of the carboxymethyl cellulose in the invention is more preferably 1.0 to 1.5.

It is preferable that the negative electrode active material layer in the invention contain a rubber-based binding agent. Thereby, the negative electrode plates will have superior adhesion between the negative electrode active materials and between the negative electrode active material layers and the negative electrode substrates.

Styrene-butadiene rubber (SBR), carboxy-denatured styrene-butadiene rubber, acrylonitrile butadiene rubber (NBR), acrylate butadiene rubber, or the like, can be used as the rubber-based binding agent. It is especially preferable that styrene-butadiene rubber be used.

It is preferable that the quantity of rubber-based binding agent contained in the negative electrode active material layer be 0.5 to 1.5% by mass relative to the total quantity of the negative electrode active material. Thereby, the negative electrode plates will have superior flexibility, and the nonaqueous electrolyte secondary battery will have a smaller decline in battery capacity due to cycling.

It is preferable that the laminate outer casing in the invention be sealed under reduced pressure. Thereby, the decline in the battery capacity when cycling is executed at high rate will be curbed in the nonaqueous electrolyte secondary battery.

It is preferable that the ratio of the spheroidal graphite and the scalelike graphite contained in the negative electrode active material layer of the invention be 7:3 to 9.5:0.5 by mass. Thereby, the decline in the battery capacity when cycling is executed at high rate will be further curbed in the nonaqueous electrolyte secondary battery.

It is preferable that the positive electrode plates and negative electrode plates in the invention each have a plate area of not less than 7,000 mm². With a medium- or large-size nonaqueous electrolyte secondary battery in which the electrode plates and negative electrode plates each have a plate area of not less than 7,000 mm², cycling can be possible at higher rates, although on the other hand, the decline in the battery characteristics due to cycling is marked. Hence, by applying the invention to secondary batteries, greater advantages can be obtained. As used here, “plate area” is the area, viewed from above, of the region on the electrode plate where the active material layer is formed.

### BRIEF DESCRIPTION OF THE DRAWINGS

The invention will be described with reference to the accompanying drawings, wherein like numbers reference like elements.

FIG. 1 is a perspective view of a nonaqueous electrolyte secondary battery pertaining to Examples and Comparative Examples of the invention.

FIG. 2A is a top view of a positive electrode plate used in the nonaqueous electrolyte secondary battery pertaining to Examples and Comparative Examples of the invention, and FIG. 2B is a top view of a negative electrode plate used in the nonaqueous electrolyte secondary battery pertaining to Examples and Comparative Examples of the invention.

FIG. 3 is a transparent top view of a pouch-like separator with a positive electrode plate disposed inside, which is used in the nonaqueous electrolyte secondary battery pertaining to Examples and Comparative Examples of the invention.

FIG. 4 is a drawing that illustrates the method of manufacturing the stacked electrode assembly used in the nonaqueous electrolyte secondary battery pertaining to Examples and Comparative Examples of the invention.

### DESCRIPTION OF EXEMPLARY EMBODIMENTS

Exemplary embodiments of the invention will now be described in detail. It should be understood, however, that these embodiments are intended by way of illustration, and that the invention is by no means limited to these particular nonaqueous electrolyte secondary batteries. Those skilled in the art will be able to vary the embodiments appropriately without departing from the spirit and scope of the claims.

First, the methods of fabricating the nonaqueous electrolyte secondary battery pertaining to Examples and Comparative Examples will be described.

Fabrication of Positive Electrode Plates

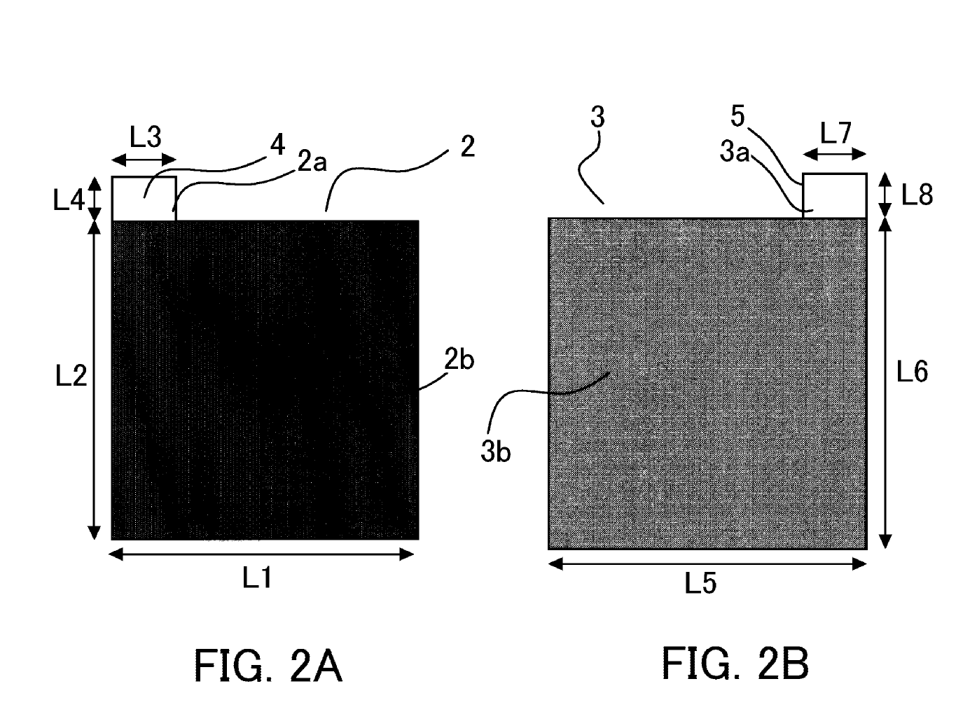

A positive electrode mixture slurry was prepared by mixing together 90% by mass of LiCoO₂ serving as positive electrode active material, 5% by mass of carbon black serving as conductive agent, and 5% by mass of polyvinylidene fluoride serving as binding agent, in a solution of N-methyl-2-pyrrolidone (NMP) as a solvent. This positive electrode mixture slurry was spread over both sides of aluminum foil (thickness: 15 μm) serving as the positive electrode substrate. Then, the solvent was removed by heating, and the item was rolled to thickness of 0.18 mm and cut to width L1=85 mm, height L2=85 mm, to produce a positive electrode plate 2 having a positive electrode active material layer 2b on both sides, as shown in FIG. 2A. An active material uncoated portion 2a was made to extend with width L3=30 mm and height L4=20 mm from an edge of the positive electrode plate 2 and used as a positive electrode collector tab 4. The plate area of the positive electrode plate 2 was 7,225 mm².

Fabrication of Pouch-like Separator with Positive Electrode Plate Disposed Inside

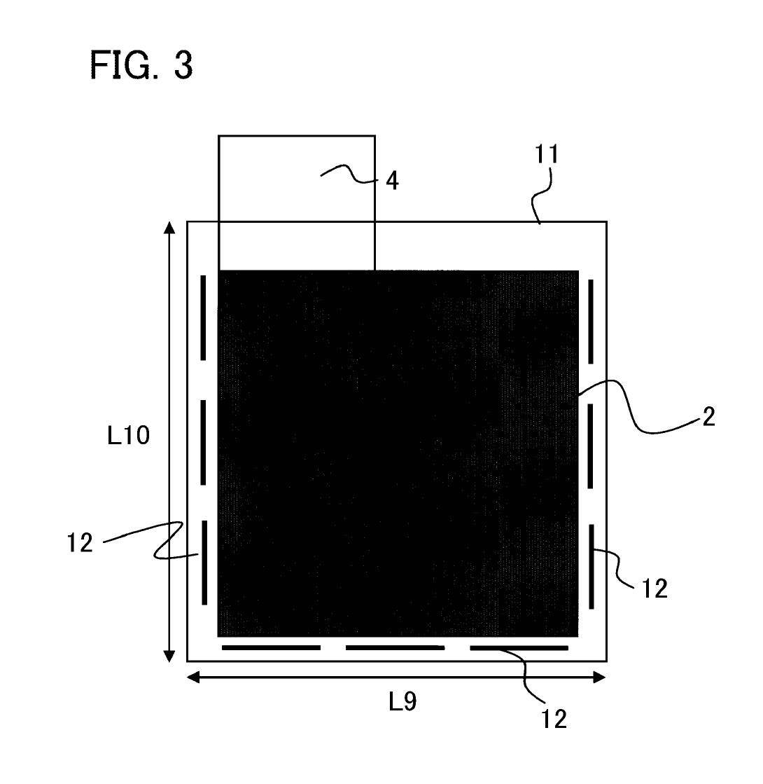

As shown in FIG. 3, the positive electrode plate 2 was disposed between two rectangular polypropylene (PP) separators of width L9=90 mm and height L10=94 mm (thickness 30 μm), then the three edges of the separators other than that where the positive electrode collector tab 4 protruded were thermally welded to fabricate a pouch-like separator 11 with a positive electrode plate 2 housed/disposed inside. Thermal weld portions 12 were formed at the parts of the pouch-like separator 11 that had been thermally welded, as shown in FIG. 3.

Fabrication of Negative Electrode Plate

Using a ROBOMIX (T.K. ROBOMIX) mixing system made by Primix Corporation, carboxymethyl cellulose (CMC) was dissolved into deionized water to produce a CMC solution. Next, using a HIVIS MIX (T.K. HIVIS MIX 2P-1) system made by Primix Corporation, spheroidal graphite and scalelike graphite serving as the negative electrode active material were mixed with the CMC solution. Then, by adding and mixing styrene-butadiene rubber (SBR) and deionized water for viscosity adjustment into such mixture, a negative electrode mixture slurry was obtained. The ratio between the spheroidal and scalelike graphites, the CMC and the SBR in the negative electrode mixture slurry was made to be the graphites 98:CMC 1:SBR 1. After that, the negative electrode mixture slurry was coated, via the reverse coat method, onto both sides of copper foil (thickness: 10 μm) serving as the negative electrode substrate, and dried at 60° C. Following that, the item was rolled to thickness of 0.14 mm and cut to width L5=90 mm, height L6=90 mm, to produce a negative electrode plate 3 having a negative electrode active material layer 3b on both sides, as shown in FIG. 2B. An active material uncoated portion 3a was made to extend with width L7=30 mm and height L8=20 mm from the edge of the negative electrode plate 3 and used as a negative electrode collector tab 5. The plate area of the negative electrode plate 3 was 8100 mm².

Fabrication of Stacked Electrode Assembly

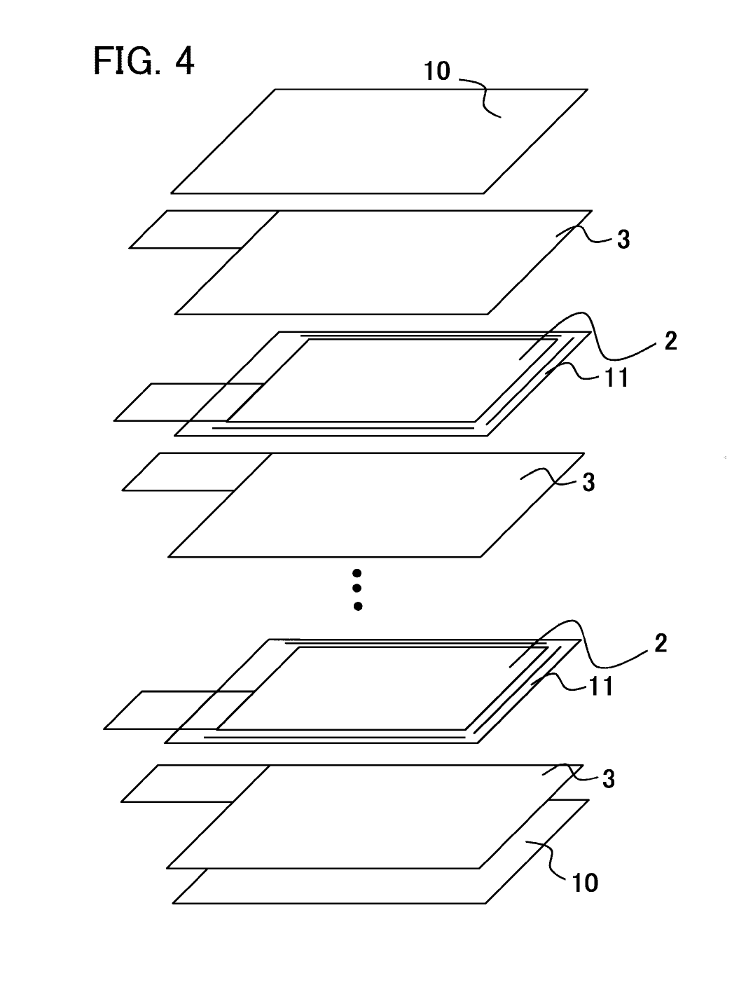

Four pouch-like separators 11 with a positive electrode plate 2 disposed inside, and five negative electrode plates 3, were fabricated by the foregoing methods and stacked alternately as shown in FIG. 4, so that a negative electrode plate 3 was positioned at both ends in the stacking direction. Furthermore, on the outside at both ends, a polypropylene (PP) insulating sheet 10 of the same dimensions and shape as the separators was disposed. Then both ends of this electrode assembly were fastened with insulating tape to maintain the shape, thus producing a stacked electrode assembly.

Welding of Collector Terminals

The positive electrode collector tabs 4 of the positive electrode plates 2 were gathered into a bundle and welded to a positive electrode collector terminal 6 consisting of 30 mm wide, 30 mm long and 0.4 mm thick aluminum sheet by the ultrasonic welding method. Likewise, the negative electrode collector tabs 5 of the negative electrode plates 3 were gathered into a bundle and welded to a negative electrode collector terminal 7 consisting of 30 mm wide, 30 mm long and 0.4 mm thick copper sheet by the ultrasonic welding method. A positive electrode tab plastic 8 and a negative electrode tab plastic 9 were stuck onto the positive electrode terminal 6 and the negative electrode terminal 7 respectively. As will be described later, the positive electrode tab plastic 8 and negative electrode tab plastic 9 are interposed between the laminate outer casing 1 and the positive electrode terminal 6 and negative electrode terminal 7 respectively, enhancing the adhesion of the positive electrode terminal 6 and negative electrode terminal 7 to the laminate outer casing 1, and thereby enhancing the sealing of the laminate outer casing 1.

Sealing into Outer Casing

The electrode assembly fabricated by the foregoing method was inserted into the laminate outer casing 1, which had been formed into a cup-shape in advance to enable installation of the electrode assembly, in such a manner that the positive electrode terminal 6 and negative electrode terminal 7 protruded outside the laminate outer casing 1. The three edges other than the edge where the positive electrode terminal 6 and negative electrode terminal 7 were located were then thermally welded, with the positive electrode tab plastic 8 and negative electrode tab plastic 9 interposed between the laminate outer casing 1 and the positive electrode terminal 6 and negative electrode terminal 7 respectively.

Pouring of Electrolyte and Sealing

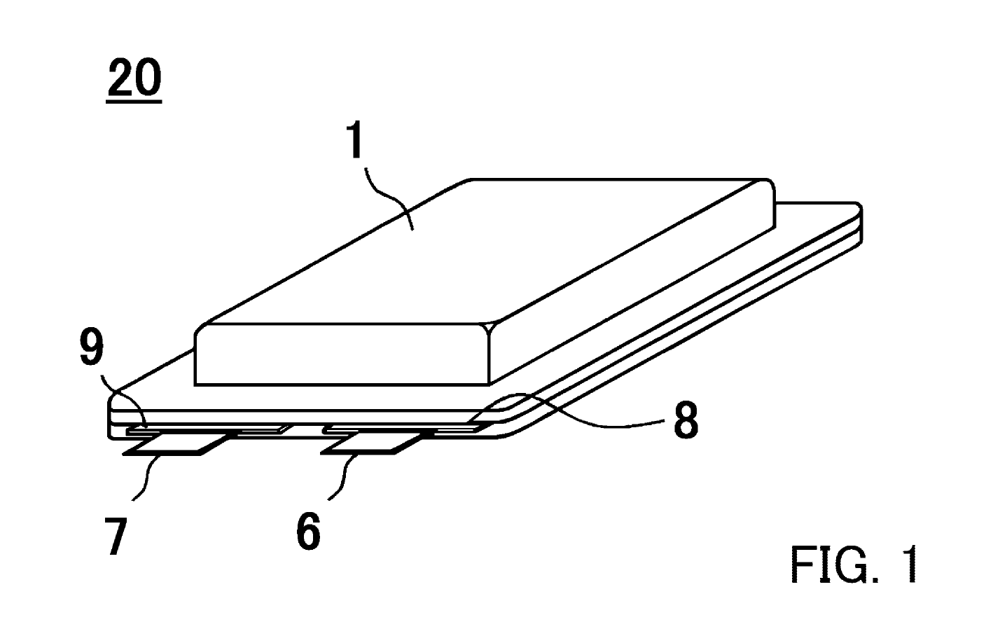

Through the one edge of the laminate outer casing 1 that had not been thermally welded, electrolyte consisting of LiPF₆ dissolved in a proportion of 1M ( [symbol] ) in a solution of ethylene carbonate (EC) and methylethyl carbonate (MEC) mixed in the ratio 30:70 by volume was poured. Finally, the one edge of the laminate outer casing 1 that had not been thermally welded was thermally welded under reduced pressure to produce a nonaqueous electrolyte secondary battery 20 shown in FIG. 1.

Next will be described the methods for fabricating the nonaqueous electrolyte secondary battery of each of Examples 1 to 4 and Comparative Examples 1 to 5.

### Example 1

Spheroidal graphite with specific surface area 1.4 m²/g and scalelike graphite with specific surface area 7.0 m²/g were mixed in the ratio 9:1 by mass, and used together with CMC with a 1.2 to 1.5 degree of etherification to fabricate the negative electrode plates for Example 1 by the method described above. The negative electrode plates for Example 1 were then used to fabricate the nonaqueous electrolyte secondary battery of Example 1 by the method described above. The average specific surface area of the spheroidal graphite and the scalelike graphite in this case was 2.0 m²/g.

### Example 2

Except that spheroidal graphite with specific surface area 2.8 m²/g was used instead of spheroidal graphite with specific surface area 1.4 m²/g, the nonaqueous electrolyte secondary battery of Example 2 was fabricated by the same method as that for Example 1. The average specific surface area of the spheroidal graphite and the scalelike graphite in this case was 3.2 m²/g.

### Example 3

Except that spheroidal graphite with specific surface area 3.7 m²/g was used instead of spheroidal graphite with specific surface area 1.4 m²/g, the nonaqueous electrolyte secondary battery of Example 3 was fabricated by the same method as that for Example 1. The average specific surface area of the spheroidal graphite and the scalelike graphite in this case was 4.0 m²/g.

### Example 4

Except that CMC with a 0.8 to 1.1 degree of etherification was used instead of CMC with a 1.2 to 1.5 degree of etherification, the nonaqueous electrolyte secondary battery of Example 4 was fabricated by the same method as that for Example 2.

### Comparative Example 1

Except that spheroidal graphite with specific surface area 1.1 m²/g was used instead of spheroidal graphite with specific surface area 1.4 m²/g, the nonaqueous electrolyte secondary battery of Comparative Example 1 was fabricated by the same method as that for Example 1. The average specific surface area of the spheroidal graphite and the scalelike graphite in this case was 1.7 m²/g.

### Comparative Example 2

Except that spheroidal graphite with specific surface area 4.4 m²/g was used instead of spheroidal graphite with specific surface area 1.4 m²/g, the nonaqueous electrolyte secondary battery of Comparative Example 2 was fabricated by the same method as that for Example 1. The average specific surface area of the spheroidal graphite and the scalelike graphite in this case was 4.7 m²/g.

### Comparative Example 3

Except that CMC with a 0.65 to 0.75 degree of etherification was used instead of CMC with a 1.2 to 1.5 degree of etherification, the nonaqueous electrolyte secondary battery of Comparative Example 3 was fabricated by the same method as that for Example 2.

### Comparative Example 4

Except that no scalelike graphite was used and spheroidal graphite with specific surface area 3.2 m²/g was used alone, the nonaqueous electrolyte secondary battery of Comparative Example 4 was fabricated by the same method as that for Example 2.

### Comparative Example 5

Except that no spheroidal graphite was used and scalelike graphite with specific surface area 3.2 m²/g was used alone, the nonaqueous electrolyte secondary battery of Comparative Example 5 was fabricated by the same method as that for Example 2.

Next, the method of fabricating the nonaqueous electrolyte secondary battery of Comparative Example 6 will be described.

### Comparative Example 6

Spheroidal graphite with specific surface area 2.8 m²/g and scalelike graphite with specific surface area 7.0 m²/g were mixed in the ratio 9:1 by mass, and used together with CMC with a 1.2 to 1.5 degree of etherification to fabricate a negative electrode plate by the method described above. This negative electrode plate was then cut into a long shape of width 57 mm, length 550 mm to produce the negative electrode plate for Comparative Example 6. The average specific surface area of the spheroidal graphite and the scalelike graphite in this case was 3.2 m²/g. A positive electrode plate was fabricated by the method described above and cut into a long shape of width 55 mm, length 500 mm to produce the positive electrode plate for Comparative Example 6. An active material uncoated portion was provided on a longitudinal edge of the negative electrode plate and of the positive electrode plate, and these active material uncoated portions were connected to a positive electrode lead and a negative electrode lead respectively. Then, the positive electrode and negative electrode were rolled up with a long-shaped separator (width 58.5 mm, length 570 mm) interposed therebetween, to fabricate a wound electrode assembly. A nonaqueous electrolyte was prepared that consisted of LiPF₆ dissolved in a proportion of 1M (mole/liter) into a solution of ethylene carbonate (EC) and methylethyl carbonate (MEC) mixed in the ratio 30:70 by volume. Then, the wound electrode assembly was inserted into a bottomed cylindrical outer can, the positive electrode lead was connected to the sealing piece, and the negative electrode lead was connected to the bottom of the outer can. After that, the nonaqueous electrolyte was poured into the outer can interior, and the mouth portion of the outer can was sealed by crimping, thus completing fabrication of the nonaqueous electrolyte secondary battery of Comparative Example 6 having a diameter of 18 mm and a height of 65 mm. The quantity of nonaqueous electrolyte that was poured into the outer can interior was the same as the quantity in Examples 1 to 4 and Comparative Examples 1 to 5.

Furthermore, the degree of etherification of CMC in Examples 1 to 4 and Comparative Examples 1 to 6 was determined in the following manner.

### Determination of Degree of Etherification of CMC

1.0 g of CMC was measured out, wrapped in filter paper, and allowed to ash. This was then transferred to a triangular flask, and around 500 ml of water and 70 ml of 0.05 [symbol] sulfuric acid were added. This solution was then boiled. Then, the solution was cooled, phenolphthalein indicator was added, the excess acid was back-titrated with 0.1 [symbol] sodium hydroxide, and the degree of ether substitution was calculated by the following equations (I) and (II):

A=(af−bf)/Quantity of CMC (g)−Alkalinity (I)

Degree of etherification=(162×/ [symbol] 0000−80A) (II)

The symbols in equations (I) and (II) represent the following:

A: quantity (ml) of 0.05 [symbol] sulfuric acid that was consumed by the combined alkali in 1 g of CMC
a: quantity (ml) of 0.05 [symbol] sulfuric acid that was used
f: potency of 0.05 [symbol] sulfuric acid
b: titer of 0.1 [symbol] sodium hydroxide (ml)

Note that the design battery capacity for the nonaqueous electrolyte secondary batteries in each of Examples 1 to 4 and Comparative Examples 1 to 6 was 1,000 mAh. The packing density of the negative electrode active material layer on the negative electrode plates in each of Examples 1 to 4 and Comparative Examples 1 to 6 was 1.6 g/cc.

The tests described below were carried out on the nonaqueous electrolyte secondary batteries of Examples 1 to 4 and Comparative Examples 1 to 6.

Measurement of Discharge Capacity for One Cycle

First of all, at 25° C., each battery was charged with constant current of 2 It (2C) until the battery voltage reached 4.2 V, then charged with constant voltage of 4.2 V until the current level fell to 25 mA. After that, at 25° C., each battery was discharged with constant current of 1 It until the battery voltage reached 2.9 V, and the discharge capacity at that point was determined as the discharge capacity for one cycle.

Measurement of Cycling Characteristic

After having their discharge capacity for one cycle measured, the batteries were, at 25° C., charged with constant current of 2 It (2C) until the battery voltage reached 4.2 V, then charged with constant voltage of 4.2 V until the current level fell to 25 mA. After that, at 25° C., the batteries were discharged with constant current of 1 It until the battery voltage reached 2.9 V. This was taken to be one cycle, and the discharge capacity for 50 cycles was then determined and used to determine the capacity retention rate by the calculation equation below. The resting time between charging and discharging was 30 minutes.

Capacity retention rate(%)=(discharge capacity for 50/ [symbol] capacity for one cycle)×100

Table 1 gathers together the components of, and the results of cycling characteristic measurements for, Examples 1 to 4 and Comparative Examples 1 to 6.

TABLE 1

| | | Average | | | | | | | |
|---|---|---|---|---|---|---|---|---|---|
| | | specific | | | | Packing | | | |
| | | surface area | Specific | Specific | | density of | | | |
| | Negative | of spheroidal | surface area | surface area | | negative | | | Capacity |
| | electrode | and scalelike | of spheroidal | of scalelike | Degree of | electrode | | | retention |
| | active | graphites | graphite | graphite | etherification | active material | Electrode | Outer | rate |
| | material | (m²/g) | (m²/g) | (m²/g) | of CMC | layer (g/cc) | assembly | casing | (50 cycles) |
| Comparative | Spheroidal + | 1.7 | 1.1 | 7.0 | 1.2 to 1.5 | 1.6 | Stacked | Laminate | 93% |
| Example 1 | scalelike | | | | | | | | |
| | graphites | | | | | | | | |
| Example 1 | Spheroidal + | 2.0 | 1.4 | 7.0 | 1.2 to 1.5 | 1.6 | Stacked | Laminate | 96% |
| | scalelike | | | | | | | | |
| | graphites | | | | | | | | |
| Example 2 | Spheroidal + | 3.2 | 2.8 | 7.0 | 1.2 to 1.5 | 1.6 | Stacked | Laminate | 96% |
| | scalelike | | | | | | | | |
| | graphites | | | | | | | | |
| Example 3 | Spheroidal + | 4.0 | 3.7 | 7.0 | 1.2 to 1.5 | 1.6 | Stacked | Laminate | 95% |
| | scalelike | | | | | | | | |
| | graphites | | | | | | | | |
| Comparative | Spheroidal + | 4.7 | 4.4 | 7.0 | 1.2 to 1.5 | 1.6 | Stacked | Laminate | 91% |
| Example 2 | scalelike | | | | | | | | |
| | graphites | | | | | | | | |
| Comparative | Spheroidal + | 3.2 | 2.8 | 7.0 | 0.65 to 0.75 | 1.6 | Stacked | Laminate | 93% |
| Example 3 | scalelike | | | | | | | | |
| | graphites | | | | | | | | |
| Example 4 | Spheroidal + | 3.2 | 2.8 | 7.0 | 0.8 to 1.1 | 1.6 | Stacked | Laminate | 95% |
| | scalelike | | | | | | | | |
| | graphites | | | | | | | | |
| Comparative | Spheroidal | 3.2 | 3.2 | — | 1.2 to 1.5 | 1.6 | Stacked | Laminate | 94% |
| Example 4 | graphite | | | | | | | | |
| Comparative | Scalelike | 3.2 | — | 3.2 | 1.2 to 1.5 | 1.6 | Stacked | Laminate | 91% |
| Example 5 | graphite | | | | | | | | |
| Comparative | Spheroidal + | 3.2 | 2.8 | 7.0 | 1.2 to 1.5 | 1.6 | Wound | Can | 90% |
| Example 6 | scalelike | | | | | | | (cylindrical) | |
| | graphites | | | | | | | | |

With Examples 1 to 3, in which the average specific area of the spheroidal graphite and the scalelike graphite was 2.0 to 4.0 m²/g, the capacity retention rate was a high value of 95 to 96%. By contrast, with Comparative Example 1, in which the average specific area of the spheroidal graphite and the scalelike graphite was 1.7 m²/g, the capacity retention rate was 93%, and with Comparative Example 2, in which the average specific area of the spheroidal graphite and the scalelike graphite was 4.7 m²/g, the capacity retention rate was 91%, which were low values compared with Examples 1 to 3.

This is thought probably to be as follows. If the average specific area of the spheroidal graphite and the scalelike graphite is smaller than 2.0 m²/g, the lithium ions in the graphite are not readily absorbed, and when cycling is executed at high rate, part of the lithium metal is precipitated, and since the precipitated lithium metal does not contribute to charging/discharging, the capacity declines with cycling. It is also thought that if the average specific area of the spheroidal graphite and the scalelike graphite is larger than 4.0 m²/g, the reactions between the graphite surfaces and the nonaqueous electrolyte become excessive and gas is produced, so that the capacity declines with cycling. By contrast, it is thought that if the average specific area of the spheroidal graphite and the scalelike graphite is made to be 2.0 to 4.0 m²/g, the foregoing issues will not arise, and the battery will have a high capacity retention rate even if cycling is executed at high rate.

With Example 4, in which the degree of etherification of the CMC was 0.8 to 1.1, and Example 2, in which the degree of etherification of the CMC was 1.2 to 1.5, the capacity retention rates were the high values of 95% and 96% respectively. By contrast, with Comparative Example 3, in which the degree of etherification of the CMC was 0.65 to 0.75, the capacity retention rate was 93%, which was a low value compared with Examples 2 and 4.

This is thought probably to be as follows. If the degree of etherification of the CMC is lower than 0.8, the affinity between the CMC and the graphite becomes too high, and the CMC covers the surfaces of the spheroidal graphite and the scalelike graphite excessively, leading to decline of the battery capacity as a result of cycling. By contrast, it is thought that if CMC with a degree of etherification of 0.8 to 1.5 is used, then the CMC will not cover the surfaces of the spheroidal graphite and the scalelike graphite excessively, and the battery will have a high capacity retention rate even if cycling is executed at high rate.

With Example 2, which used a mixture of spheroidal graphite and scalelike graphite, the capacity retention rate was the high value of 96%. By contrast, with Comparative Example 4, which used spheroidal graphite alone, and Comparative Example 5, which used scalelike graphite alone, the capacity retention rates were 94% and 91% respectively, which were low values compared with Example 2. It is thought that when spheroidal graphite alone is used, the diffusibility of the lithium ions into the graphite is poor, so that cycling at high rate causes the spheroidal graphite to degrade and the battery capacity to decline. It is also thought that when scalelike graphite alone is used, the reactivity of the scalelike graphite with the electrolyte is high, so that gas is produced as a result of cycling at high rate, and the battery capacity declines with cycling. It is thought that by using a mixture of spheroidal graphite and scalelike graphite, the spheroidal graphite can be curbed from degrading and production of gas can be suppressed, so that the battery will have a high capacity retention rate even if cycling is executed at high rate.

With Example 2, in which a stacked electrode assembly was housed in a laminate outer casing, the capacity retention rate was the high value of 96%. By contrast, with Comparative Example 6, in which a wound electrode assembly was housed in a cylindrical outer casing, the capacity retention rate was 90%, which was a low value compared with Example 2.

It is thought that the reason why the capacity retention rate was a low value in Comparative Example 6, in which a wound electrode assembly was housed in a cylindrical outer casing, was that regions where electrolyte was insufficient arose inside the wound electrode assembly as a result of cycling at high rate. It is thought that although there was surplus electrolyte present between the wound electrode assembly and the outer casing, the fact that the assembly was of the wound type meant that the surplus electrolyte was not readily supplied to the regions where electrolyte was consumed. It is further thought that with Comparative

Example 6, in which a wound electrode assembly was housed in a cylindrical outer casing, voids were prone to occur in the central portion of the wound electrode assembly and between the wound electrode assembly and the outer can, which inhibited surplus electrolyte from being present in the vicinity of the electrode assembly, and so that the surplus electrolyte was not readily supplied to the regions where electrolyte was consumed.

By contrast, it is thought that with Example 2, in which a stacked electrode assembly was housed in a laminate outer casing, the fact that the assembly was of the stacked type meant that electrolyte was readily supplied to any regions where electrolyte was consumed, and no region where electrolyte was insufficient was apt to arise. It is further thought that with Example 2, in which a stacked electrode assembly was housed in a laminate outer casing, the fact that the assembly was of the stacked type meant that there were no voids in the central portion, as there were with the wound electrode assembly, and voids were not liable to occur between the stacked electrode assembly and the laminate outer casing, so that the surplus electrolyte was readily present in the vicinity of the stacked electrode assembly. Hence, it is thought that surplus electrolyte present between the stacked electrode assembly and the laminate outer casing was immediately supplied to any regions where electrolyte was consumed that occurred as a result of cycling at high rate, so that regions where electrolyte was insufficient were not liable to occur, and the battery capacity was curbed from declining. Such advantages will be more readily obtained if the laminate outer casing is sealed under reduced pressure.

Thus, in a nonaqueous electrolyte secondary battery having the components of the invention, due to the synergistic effects of the components, the battery capacity will be curbed from declining even when cycling is executed at high rate.

Among the items that can be used as the positive electrode active material in the nonaqueous electrolyte secondary battery of the invention are lithium cobalt oxide (LiCoO₂), lithium manganese oxide (LiMn₂O₄), lithium nickel oxide (LiNiO₂), lithium nickel manganese complex oxide (LiNi₁₋ₓMnₓO₂ (0<x<1)), lithium nickel cobalt complex oxide (LiNi₁₋ₓCoₓO₂ (0<x<1)), lithium nickel cobalt manganese complex oxide (LiNiₓCo_{y}Mn_{z}O₂ (0<x<1, 0<y<1, 0<z<1, x+y+z=1)), or other lithium transition metal complex oxide. Such lithium transition metal complex oxide could be used with Al, Ti, Zr, Nb, B, Mg, Mo, or the like added. An example that may be cited is the lithium transition metal complex oxide expressed by Li₁₊ₐNiₓCo_{y}Mn_{z}M_{b}O₂ (M=at least one element selected from among Al, Ti, Zr, Nb, B, Mg and Mo, 0≦a≦0.2, 0.2≦x≦0.5, 0.2≦y≦0.5, 0.2≦z≦0.4, 0≦b≦0.02, a+b+x+y+z=1).

Besides the use of spheroidal graphite and scalelike graphite as the negative electrode active material in the invention, these could be used impregnated with small amounts of a substance that enables insertion and removal of lithium ions, such as graphitized pitch-based carbon fiber, non-graphitizable carbon, graphitizable carbon, pyrolitic carbon, glassy carbon, baked organic polymer compound, carbon fiber, activated carbon, coke, tin oxide, silicon, silicon oxide, or a mixture of these. In such a case, the proportion of such substance is preferably not more than 10% by mass relative to the total amount of spheroidal graphite and scalelike graphite, or more preferably not more than 5% by mass.

As the nonaqueous solvent (organic solvent) for the nonaqueous electrolyte in the nonaqueous electrolyte secondary battery of the invention, it is possible to use a carbonate, a lactone, an ether, a ketone, an ester, or the like, which have long been in general use in nonaqueous electrolyte secondary batteries, or a mixture of two or more of these solvents. For example, a cyclic carbonate such as ethylene carbonate, propylene carbonate, or butylene carbonate, or a chain carbonate such as dimethyl carbonate, ethylmethyl carbonate, or diethyl carbonate, could be used. It is particularly preferable to use a mixed solvent of cyclic carbonate and chain carbonate. An unsaturated cyclic carbonate such as vinylene carbonate (VC) could be added to the nonaqueous electrolyte.

As the electrolytic salt for the nonaqueous electrolyte in the nonaqueous electrolyte secondary battery of the invention, it is possible to use an item that has long been in general use in lithium ion secondary batteries. For example, LiPF₆, LiBF₄, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, LiB(C₂O₄)₂, LiB(C₂C₄)F₂, LiP(C₂O₄)₃, LiP(C₂O₄)₂F₂, LiP(C₂O₄)F₄, or the like, or a mixture of these, can be used. Of these items, it is particularly preferable to use LiPF₆. The dissolved volume of the electrolytic salt relative to the nonaqueous solvent is preferably 0.5 to 2.0 mol/L.

As the laminate outer casing in the invention, a metal sheet with a plastic layer formed on the surface can be used. For example, an item could be used which is composed of aluminum, aluminum alloy, stainless steel or the like for the metal layer, polyethylene, polypropylene or the like for the inner layer (the battery inside), and nylon, polyethylene terephthalate (PET), or a laminated film of PET and nylon, or the like, for the outer layer (the battery outside).

What is claimed is:

1. A nonaqueous electrolyte secondary battery comprising:
a stacked electrode assembly in which positive electrode plates and negative electrode plates are stacked with separators interposed therebetween, and that is housed, together with a nonaqueous electrolyte, in a laminate outer casing,
a negative electrode active material layer being formed on the surface of negative electrode substrates of the negative electrode plates,
the negative electrode active material layer containing spheroidal graphite, scalelike graphite, and carboxymethyl cellulose,
the average specific surface area of the spheroidal graphite and the scalelike graphite being 2.0 to 4.0 m²/g,
the degree of etherification of the carboxymethyl cellulose being 0.8 to 1.5, and
the packing density of the negative electrode active material layer being 1.3 to 1.8 g′ cc.

2. The nonaqueous electrolyte secondary battery according to claim 1, wherein the degree of etherification of the carboxymethyl cellulose is 1.0 to 1.5.

3. The nonaqueous electrolyte secondary battery according to claim 1, wherein the negative electrode active material layer contains a rubber-based binding agent.

4. The nonaqueous electrolyte secondary battery according to claim 3, wherein the rubber-based binding agent is styrene-butadiene rubber.

5. The nonaqueous electrolyte secondary battery according to claim 2, wherein the negative electrode active material layer contains a rubber-based binding agent.

6. The nonaqueous electrolyte secondary battery according to claim 5, wherein the rubber-based binding agent is styrene-butadiene rubber.

7. The nonaqueous electrolyte secondary battery according to claim 1, wherein the laminate outer casing is sealed under reduced pressure.

8. The nonaqueous electrolyte secondary battery according to claim 1, wherein the ratio of the spheroidal graphite and the scalelike graphite contained in the negative electrode active material layer is 7:3 to 9.5:0.5 by mass.

9. The nonaqueous electrolyte secondary battery according to claim 1, wherein the positive electrode plates and negative electrode plates each have a plate area of not less than 7000 mm².
